(19) United States
(12) Patent Application Publication
(10) Pub. No.: US 2019/0257166 A1
(43) Pub. Date: Aug. 22, 2019

(54) GRADUAL IMPULSE FLUID PULSE VALVE

(71) Applicant: Extreme Technologies, LLC, Vernal, UT (US)

(72) Inventors: Joseph Aschenbrenner, Blackfoot, ID (US); Gilbert Troy Meier, Vernal, UT (US); Elgin McCurdy, Vernal, UT (US)

(73) Assignee: Extreme Technologies, LLC, Vernal, UT (US)

(21) Appl. No.: 16/258,076

(22) Filed: Jan. 25, 2019

Related U.S. Application Data
(63) Continuation-in-part of application No. 15/730,835, filed on Oct. 12, 2017.
Application No. 15/730,835 is a continuation-in-part of application No. 15/694,347, filed on Sep. 1, 2017.
Application No. 15/694,347 is a continuation of application No. 14/339,958, filed on Jul. 24, 2014, now Pat. No. 9,605,511.
(60) Provisional application No. 62/621,947, filed on Jan. 25, 2018.

(51) Int. Cl. E21B 28/00; E21B 7/24; F16K 31/16; E21B 34/10; F16K 31/53; E21B 31/00

(52) U.S. Cl. CPC E21B 28/00; E21B 7/24; E21B 31/005; E21B 34/10; F16K 31/535; F16K 31/16

(57) ABSTRACT

A fluid pulse valve and a method of using the fluid pulse valve are disclosed. The fluid pulse valve comprises an outer housing, a rotor contained within the outer housing, a stator tube surrounding the rotor and adjacent to the outer housing, the stator tube comprising a plurality of slots in a helical patter, and a helical closer coaxially and rotationally coupled to the rotor. At least a portion of the closer is configured to align with the plurality of slots as the closer rotates, thereby covering and uncovering the plurality of slots to create a crescendoing and decrescendoing pulse.

### PRIORITY CLAIM

This application claims the benefit of and priority to U.S. Provisional Patent Application No. 62/621,947, filed Jan. 25, 2018 and entitled “Gradual Impulse Fluid Pulse Valve.”

This application also is a Continuation-In-Part application of U.S. Non-Provisional application Ser. No. 15/730,835, filed Oct. 12, 2017, which in turn is a Continuation-In-Part application of U.S. Non-Provisional application Ser. No. 15/694,347, filed Sep. 1, 2017, which in turn is a Continuation-In-Part application of U.S. Non-Provisional application Ser. No. 15/467,389, filed Mar. 23, 2017, which in turn is a Continuation Application of U.S. Non-Provisional application Ser. No. 14/339,958, filed Jul. 24, 2014 and now U.S. Pat. No. 9,605,511, all of which are entitled “Fluid Pulse Valve,” and all of which are hereby specifically and entirely incorporated by reference.

### TECHNICAL FIELD

The embodiments of the invention disclosed herein relate to valves and, in particular, fluid pulse valves for use in the oil and gas industry.

### BACKGROUND

Rotary valves are used in industry for a number of applications like controlling the flow of liquids to molds, regulating the flow of hydraulic fluids to control various machine functions, industrial process control, and controlling fluids which are directed against work pieces. The vast majority of these applications are conducted at low fluid pressures and at either low rotational speeds or through an indexed movement. These applications have been addressed through application of various known fluid regulation valve applications including gate valves, ball valves, butterfly valves, rotating shafts with various void designs and configurations, solenoid actuated valves of various designs, and valves designed with disks with multiple holes to redirect flow streams. These applications are generally acceptable for low speed, low pressure processes, but are not suitable for high speed, high pressure processes.

For example, solenoid valves are effective for regulating fluid flow up to a frequency of approximately 300 Hz at a pressure of up to 200 psi. These limitations are primarily due to the physical design of the solenoid which relies upon the reciprocating motion of magnetic contacts and is therefore subject to significant acceleration and deceleration forces, particularly at higher frequencies. These forces, the resulting jarring action, and the frictional heat generated make these type valves subject to failure at high frequencies of actuation.

Rotary valves employing multiple outlets have been used at frequencies up to 1000 Hz in applications where a low-pressure differential between valve inlet and outlet ports is desired. These valves, however, are large and complex and necessarily have significant physical space requirements for the valve and for the appurtenant inlet and outlet piping.

Other types of valves have disadvantages that include: the valve actuation cycle speed (frequency) of the valve is too low, the valve is large and physically complex, the valve creates significant head loss, the valve cannot satisfactorily operate at high inlet pressures, or the valve cannot create the necessary frequency or amplitude of flow perturbation.

In the oil and gas industry, bores are drilled to access sub-surface hydrocarbon-bearing formations. Conventional drilling involves imparting rotation to a drill string at surface, which rotation is transferred to a drill bit mounted on a bottom hole assembly (BHA) at the distal end of the string. However, in directional drilling a downhole drilling motor may be used to impart rotation to the drill bit. In such situations it tends to be more difficult to advance the non-rotating drill string through the drilled bore than is the case when the entire length of drill string is rotating. Furthermore, during use, the drill string often becomes jammed or otherwise unable to continue drilling. Currently the entire drill string must be removed to determine the cause of and fix the problem.

For the foregoing reasons, there is a need for a high-speed, high pressure rotary valve for controlling the flow of a fluid to produce high frequency fluid pulses or perturbations. Further, there is a need for such a valve which is suitable for high pressure applications with minimal head loss through the valve and is easily removable to leave a clear bore without disrupting the entire drill string.

### SUMMARY

The present invention overcomes the problems and disadvantages associated with current strategies and designs and provides new tools and methods creating rotary valves.

One embodiment of the invention is directed to a fluid pulse valve. The valve comprises an outer housing, a rotor contained within the outer housing, a stator tube surrounding the rotor and adjacent to the outer housing, the stator tube comprising a plurality of slots, and a closer rotationally coupled to the rotor and at least a portion of the closer in line with the plurality of slots. As the closer rotates, the closer covers and uncovers the plurality of slots to create a pulse.

In a preferred embodiment, as fluid passes through the fluid pulse valve, the fluid enters the outer housing, passes through the plurality of oblong slots, into the stator and rotates the rotor. Preferably, the fluid pulse valve further comprises at least one fixed flow area port in the stator tube. Preferably, the fluid pulse valve further comprises a gearbox, wherein gear reduction within the gearbox causes the closer to rotate at a different rate than the rotor. Preferably, at least one of gear ratio of the gearbox or pitch of the rotor is adjusted to alter pulse rate relative to flow rate. The fluid pulse valve is preferably a component of a well bore string.

Preferably, the fluid pulse valve further comprises an anchor coupled to the rotor. Preferably, the anchor, the rotor, and the closer are removable from the stator tube without removing a down hole portion of the well bore string. The anchor is preferably a hold point to remove the rotor and closer from the drill string. In a preferred embodiment, the fluid pulse valve closes and opens at 0.1-10 Hz. Preferably, there are no fluid bypasses. Preferably, at least one of the slot's quantity and size and a gap between the slot and the closer are adjusted to alter pulse intensity.

Another embodiment of the invention is directed to a method of vibrating a drill string. The method comprises providing a bottom hole assembly (BHA), providing a fluid pulse valve positioned uphole of the BHA, passing fluid through the fluid pulse valve to the BHA, wherein the fluid forces the closer to rotates, which covers and uncovers the plurality of slots to create a pulse, thereby vibrating the drill string. The fluid pulse valve comprises an outer housing, a rotor contained within the outer housing, a stator tube surrounding the rotor and adjacent to the outer housing, the stator tube comprising a plurality of slots, and a closer rotationally coupled to the rotor and at least a portion of the closer in line with the plurality of slots.

Preferably, as fluid passes through the fluid pulse valve, the fluid enters the outer housing, passes through the plurality of oblong slots, into the stator and rotates the rotor. In a preferred embodiment, the fluid pulse valve further comprises at least one fixed flow area port in the stator tube. Preferably, the fluid pulse valve further comprises a gearbox, wherein gear reduction within the gearbox causes the closer to rotate at a different rate than the rotor. At least one of gear ratio of the gearbox or pitch of the rotor is preferably adjusted to alter pulse rate relative to flow rate.

In a preferred embodiment, the fluid pulse valve further comprises an anchor coupled to the rotor. Preferably, the anchor, the rotor, and the closer are removable from the stator tube without removing a down hole portion of the well bore string. The anchor is preferably a hold point to remove the rotor and closer from the drill string. Preferably, the fluid pulse valve closes and opens at 0.1-10 Hz. There are preferably no fluid bypasses in the fluid pulse valve. In a preferred embodiment, the vibrations are caused by the flow of fluid within the fluid pulse valve starting and stopping. Preferably, at least one of the slot's quantity and size and a gap between the slot and the closer are adjusted to alter pulse intensity.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 is cut away side view of an embodiment of the invention;

FIG. 2 is an exploded isometric view of the components of the invention;

FIG. 3 is a blown-up view of an embodiment of an anchor portion of the invention;

FIG. 4 is a blown-up view of an embodiment of a rotor portion of the invention;

FIG. 5A-C are views of an embodiment of a turbine portion of the invention;

FIG. 6A-B are views of an embodiment of a stator portion of the invention; and,

FIG. 7 depicts a transparent view of another embodiment of the stator and rotor.

The drawings are not necessarily to scale.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

The terms “up” and “down”; “upper” and “lower”; “upward” and downward”; “above” and “below”; and other like terms as used herein refer to relative positions to one another and are not intended to denote a particular direction or spatial orientation or perspective view

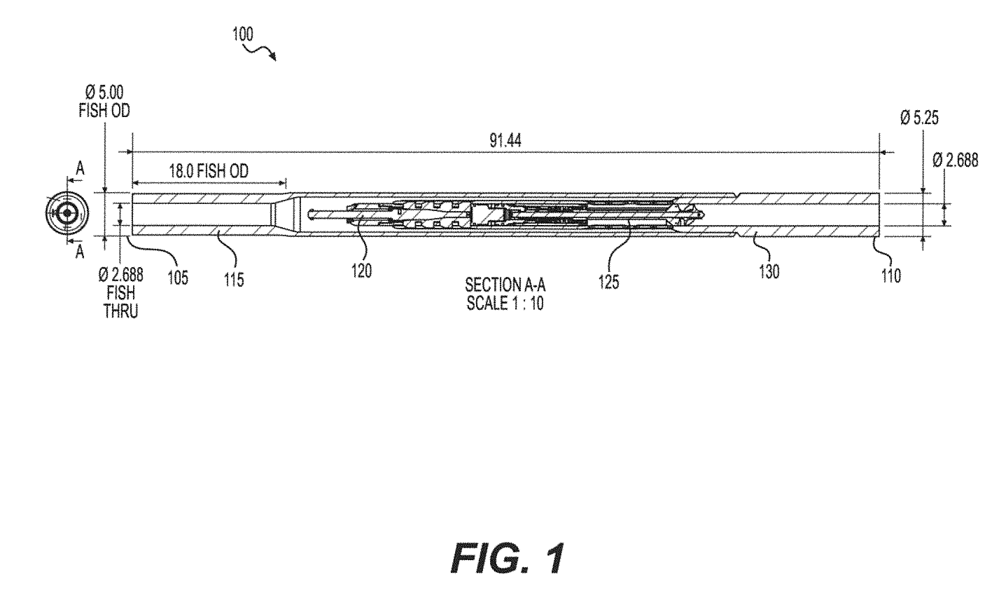

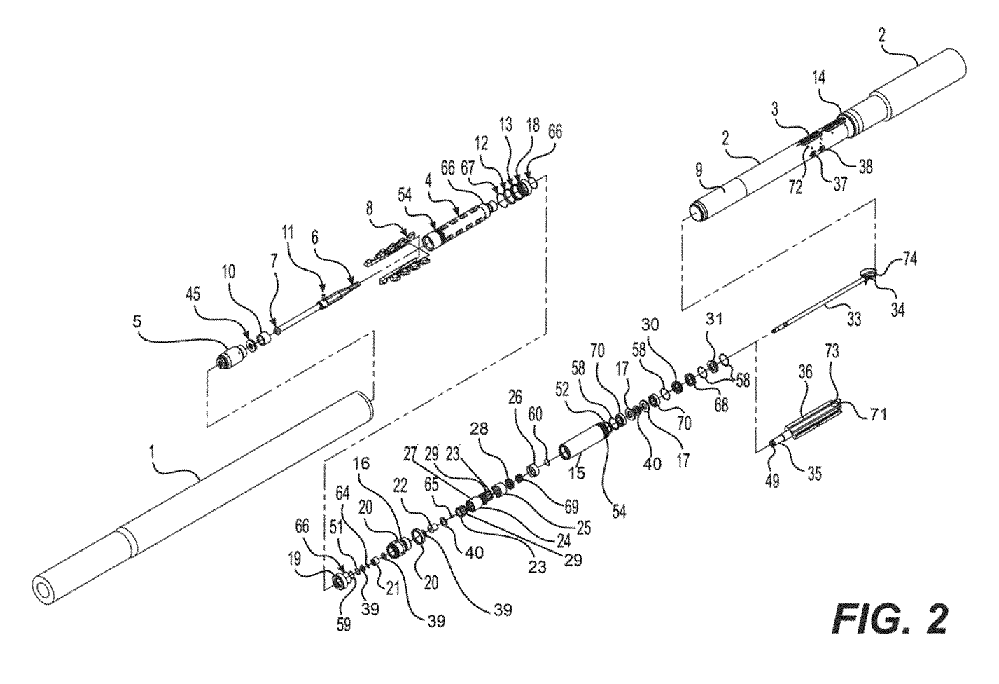

FIG. 1 depicts a cutaway side view of an embodiment of the fluid pulse valve 100. Fluid pulse valve 100 is preferably tubular in shape with the components described herein adapted to fit within the tube. In the preferred embodiment, fluid pulse valve 100 is adapted to be coupled to a downhole drill string. Preferably end 105 of fluid pulse valve 100 is coupled on the uphole portion of the drill string while end 110 is coupled to the downhill portion of the drill string such that fluid flowing though the drill string enters fluid pulse valve 100 at end 105 and exits fluid pulse valve 100 at end 110. Preferably, fluid pulse valve 100 is of equal or similar outer diameter to the drill string. Both ends of fluid pulse valve 100 are preferably couplable to the drill string via a threaded fitting. However, other coupling methods could be used, such as friction, adhesive, bolts, and rivets. FIG. 2 depicts an exploded view of fluid pulse valve 100 indicating the preferred arrangement and interaction of the various parts of fluid pulse valve 100. Table 1 lists the parts depicted in FIG. 2.

Fluid pulse valve 100 is preferably comprised of for basic parts: housing 115, anchor 120, rotor 125, and stator 130. Housing 115 makes up the majority of the outer portion of fluid pulse valve 100. Housing 115 is tubular in shape and preferably includes end 105. Preferably, the outer diameter of housing 115 is constant and may be equal to, larger, or smaller than the diameter of the drill string or the joints of the drill string. In a preferred embodiment, the inner diameter of housing 115 increases from end 105 toward end 110 of fluid pulse valve 100. The increase in diameter can be gradual, abrupt, or a combination thereof. Preferably, housing 115 is comprised of steel. However, housing 115 may be comprised of another material, for example, brass, plastic, other metals, or other manmade or naturally occurring materials. Preferably, housing 115 is detachable from the remainder of fluid pulse valve 100.

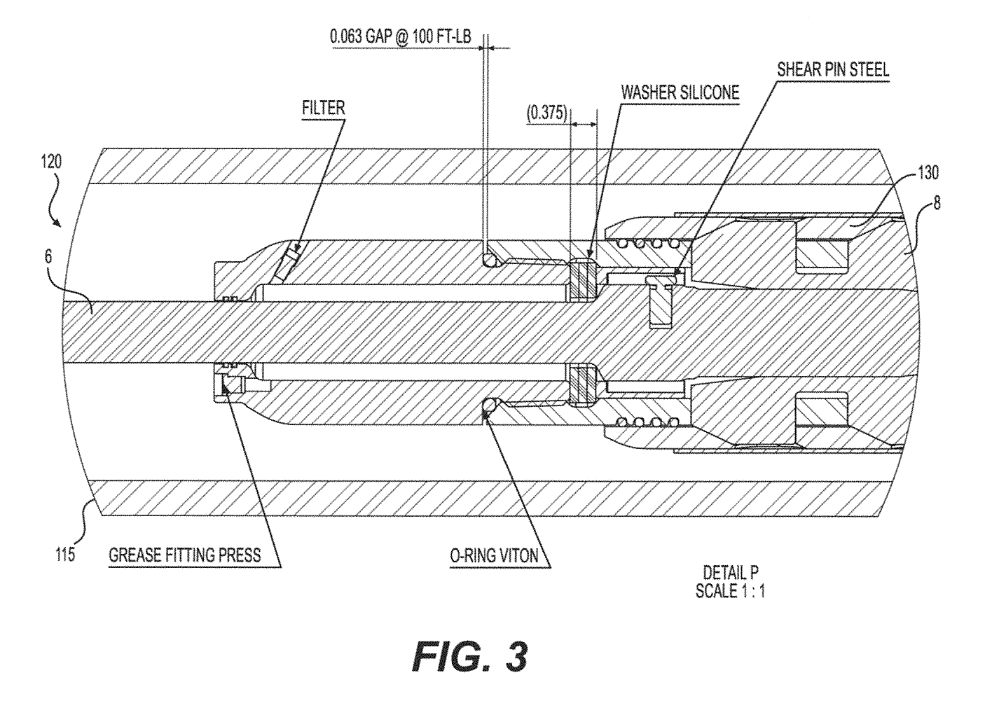

FIG. 3 depicts a blown-up view of an embodiment of anchor 120. Preferably, anchor 120 is adapted to fit within housing 115 and adjacent to end 105. In the preferred embodiment, anchor 120 is adapted to detachably couple rotor 125 to housing 115. Anchor 120 is preferably comprised of an anchor body 4 and an anchor cap 5 which are coupled together via shear collar 10. Within Anchor 120, is preferably an anchor extraction pin 6 and anchor claws 8. Preferably, anchor claws 8 engage or otherwise couple anchor 120 to stator slots within anchor seal sleeve 9 of stator 130 (as described herein). In the preferred embodiment, anchor extraction pin 6 is adapted to be a handle or attachment point to remove anchor 120 and rotor 125 from stator 130 as required by the operator of the drill. Once removed, a clear bore is left to the remaining portion of the drill string, allowing for free point tests and measure while drilling (MWD) tool retrieval. For example, if the drill becomes stuck, the operator can pull on anchor extraction pin 6 to remove anchor 120 and rotor 125 and the portions of the drill string uphole therefrom from the drill string, thereby providing a clear path to the downhole portions of the drill string to determine where the drill string is stuck or the drilling is otherwise stopped. Preferably, anchor 120 is sealed to the drilling fluid by various seals and removably secured within fluid pulse valve 100 with various fastening devices. In a preferred embodiment, anchor 120 is filled with oil or another lubricant to reduce wear, increase efficiency, and lubricate anchor 120.

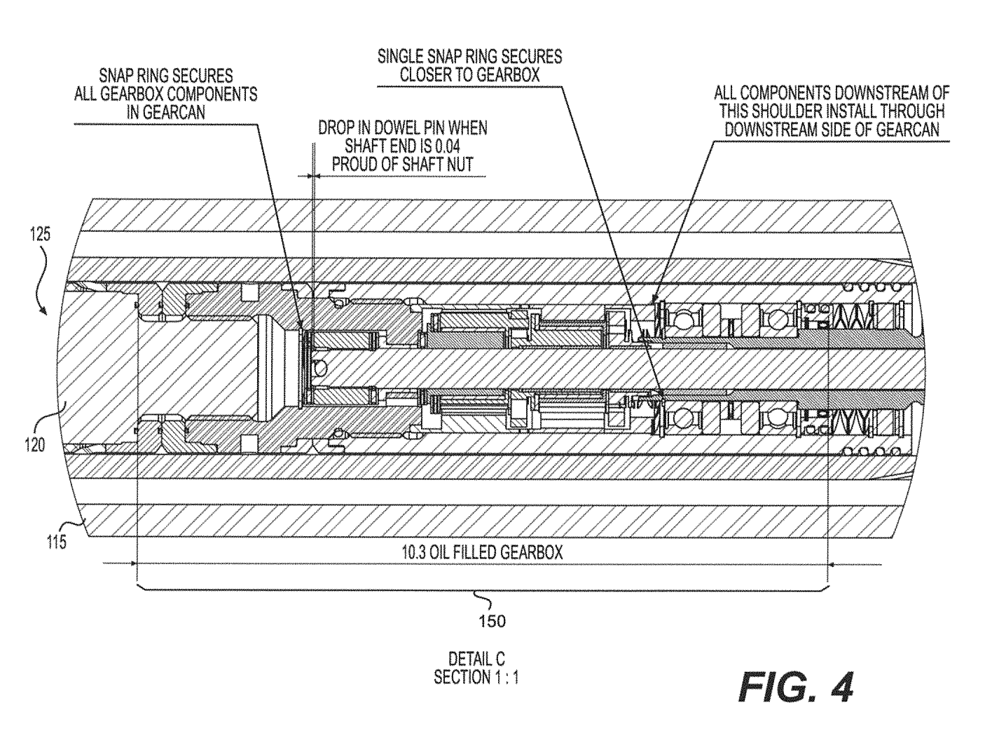

Rotor 125 is preferably comprised of a gearbox 150, a turbine 34, and a closer 35. Preferably rotor 125 is coupled to anchor 120 within housing 115. FIG. 4 is a blown-up view of gearbox 150. Preferably, gearbox 150 provides a double gear reduction. However, gearbox 150 may provide a single gear reduction or multiple gear reductions. Preferably, the gear ratio is adjustable to accommodate different uses. Preferably, gearbox 150 uses a planetary gear configuration for gear reduction. However, other gear configurations can be used. Preferably gearbox 150 has one or more valves to allow for oil expansion during use of fluid pulse valve 100. Preferably gearbox 150 is sealed to the drilling fluid by various seals and removably secured within fluid pulse valve 100 with various fastening devices. In a preferred embodiment, gearbox 150 is filled with oil or another lubricant to reduce wear, increase efficiency, and lubricate the components of gearbox 150.

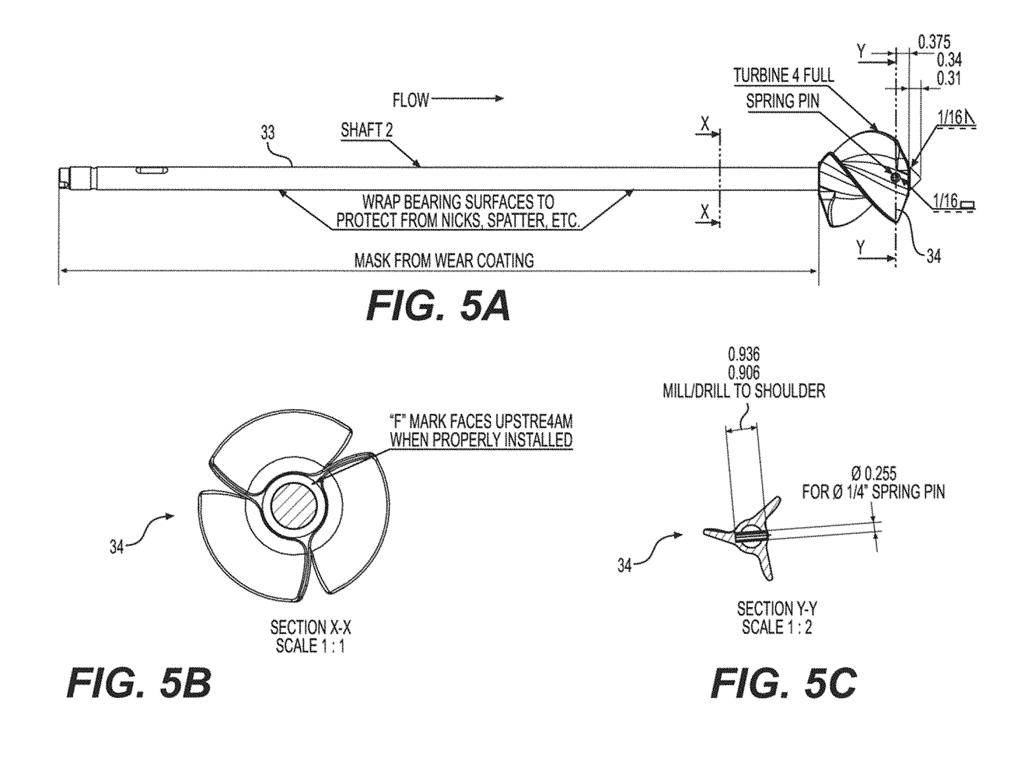

Preferably, gearbox 150 is coupled to turbine 34 via shaft 33. FIG. 5a depicts a side view an embodiment of turbine 34 and shaft 33 while FIGS. 5B-C are sectional views of the turbine 34. In the preferred embodiment, turbine 34 is a propeller or other device designed to rotate as fluid passes over it. Preferably, as turbine 34 and shaft 33 rotate, they in turn rotate the components of gearbox 150. In turn, the components of gearbox 150 rotate closer 35. Due to the gear reduction of gearbox 150, closer 35 preferably rotates at a different speed than turbine 34. Preferably, closer 35 is positioned to surround shaft 33. Preferably, at least one bearing or bushing is positioned between closer 35 and shaft 33. Closer 35 is preferably paddle shaped and adapted to cover slots 3 in stator 130, as described herein. Closer 35 can, for example, have 1, 2, 3, 4, 5, or 6 paddles. Preferably the paddles are evenly distributed about closer 14.

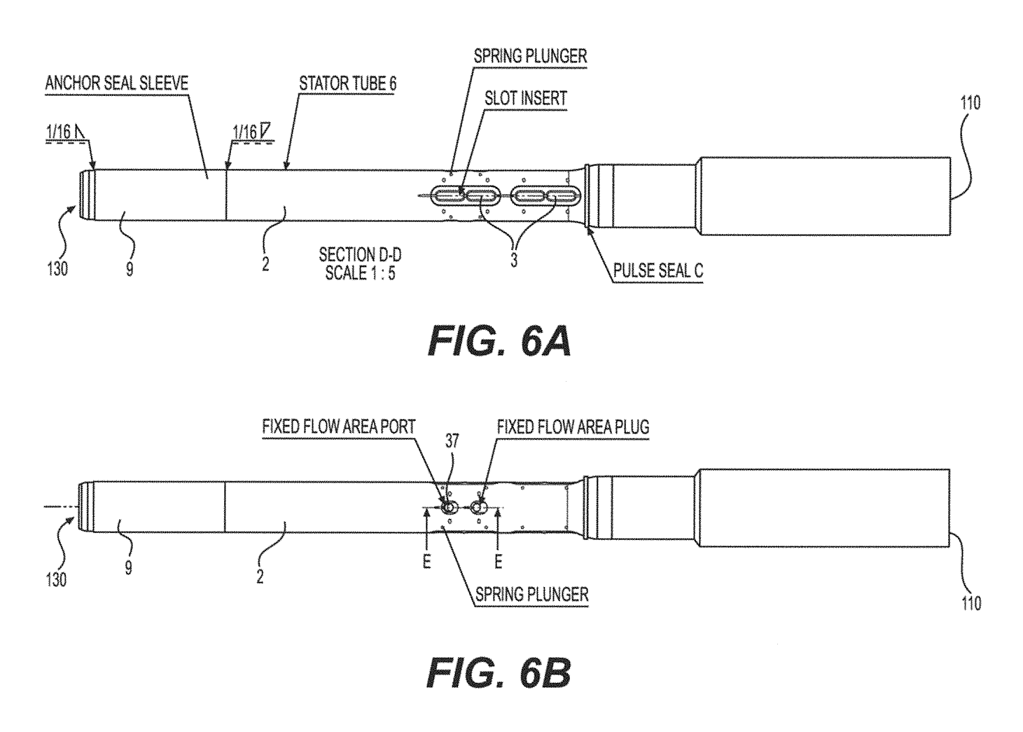

FIGS. 6A and 6B depict two side views of stator 130. Stator 130 is preferably comprised of stator tube 2 that is coupled to anchor body 4, which contains holes that are adapted to be engaged by anchor claw 8 in order to couple stator 130 to anchor 120. In the preferred embodiment, stator tube 2 surrounds gearbox 150, closer 35, and turbine 34. Furthermore, stator tube 2 preferably surrounds anchor body 4 such that anchor claw 8 removably engages both anchor body 4 and stator slots within anchor seal sleeve 9 simultaneously. Preferably, at least a portion of stator tube 2 is inserted into housing 115, while another portion extends beyond the end of housing 115 to be end 110 of fluid pulse valve 100. Preferably, stator tube 2 is coupled to housing 115 via a press fit, welded assembly. However, other devices can be used to couple the two parts together, for example, a threaded coupling, bolts, adhesive, friction, and rivets. In a preferred embodiment end 110 has an outer diameter equal to the outer diameter of housing 115.

As shown in FIG. 6A, stator tube 2 preferably has a plurality of slots 3. While eight slots are shown (four on top and four on the bottom) another number of slots can be used, for example two, four, six, ten, or twelve slots. Preferably slots 3 are in line with closer 35 such that as closer 35 is rotated, slots 3 become covered and uncovered by closer 35, creating a pulse.

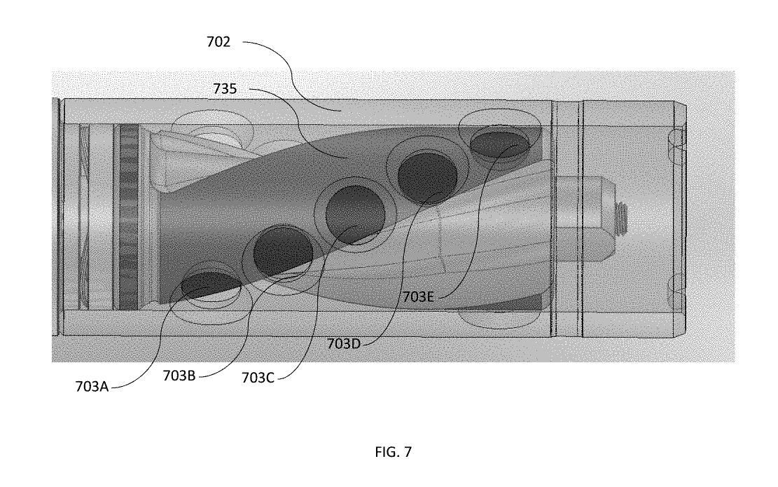

In another embodiment, as shown in FIG. 7, the position of graduated slots 703A-E create a spiral or helix along the surface of stator 702. While five slots are positioned on opposing sides of stator 702, another number of slots and another number of sets of slots may be implemented. Preferably closer 735 also has a spiral, helical, or helix shape. However, in a preferred embodiment the pitch of the helix created by slots 703A-E is not the same as the pitch of the helix of closer 735. As such, and as can be seen in FIG. 7, as closer 735 rotates, closer 735 fully covers slot 703E before fully covering slot 703D, which is fully covered before slot 703C is fully covered, and so on until finally all 5 slots are fully covered. While the slots are shown being fully covered in one order, they can be covered in another order. This gradual increase in the number of slots fully covered creates a crescendoing (or ramping-up) pulse or pressure increase if a fluid within the drill string and then a decrescendoing (or ramping down) pulse or pressure decrease of a fluid within the drill string as the number of slots uncovered increases. In embodiment where all of the slots are covered simultaneously, the pulse is a very “sharp” pulse initiation. While if the pitches are dissimilar, at pulse initiation some holes are blocked while some holes are still partially unblocked, until the closer continues its rotation and then completely blocks all holes, thereby creating a buffered pulse initiation. This can be useful to control how “violent” the tool is. It can also be useful to reduce how much the pulses interfere with pulse signals that come from other downhole measurement and telemetry equipment. Preferably, the crescendo and decrescendo of the pulse can be adjusted by varying the difference in pitches of the slots and the closer as well as varying the graduation and/or placement of the slots relative to each other.

Slots 3 are preferably oblong in shape, for example slots can be 4 inch by ½ inch, while slots 703 are preferably circular in shape. However, slots 3 or 703 can have another shape, such as circular, oblong, or rectangular. Additionally, as shown in FIG. 6B, stator tube 2 may have one or more fixed flow area ports 37 to provide a minimum flow to the turbine and provide a method of starting rotation in the event slots 3 are in line with closer 35. Fixed flow area ports 37 preferably can be sized to help control the pulse intensity of the valve. For example, larger fixed flow area ports 37 allow more fluid to flow through stator tube 2 without being interrupted by closer 35, thereby reducing the intensity of the pulse caused by the stoppage of fluid flow. Preferably, a change in the fixed flow area ports quantity and/or size can be used to adjust the pulse intensity. A change in the gap between closer 35 or 735 and slots 3 or 703 may also affect the pulse intensity. Additionally, a change in the gear ratio and or propeller pitch can preferably be used to adjust the pulse rate relative to flow rate. Such adjustments can be made upon order for a specific driller's planned flow.

The drilling fluid flows through and round stator tube 2, is often abrasive and, as it is forced though fixed flow area ports 37 and into closer 35, can be destructive. For example, as the drilling fluid flows through fixed flow area ports 37, a high-velocity jet of fluid may form that can impact and erode the valve components. In an effort to improve the life of the valve, multiple materials and coating can be used. For example, high strength alloy steel (e.g. ASI 4145 steel), wear resistant tool steels (e.g. A2 & D2 steels), HVOF applied carbide coatings up to 0.010 inches thick over alloy steel, and laser clad carbide coatings up to 0.030 inches thick over alloy steel are all potential materials and coatings. However, with each of these some erosion may occur. For example, the fluid may be able to penetrate between the coatings and the softer steel and erode the softer steel.

In a preferred embodiment, at least a portion of fluid pulse valve 100 is comprised of a ceramic material. Preferably, at least stator tube 2 and closer 35 are comprised of a ceramic material, however other parts that come into contact with the drilling fluid may also be comprised of the ceramic material. Preferably, the ceramic material is harder than the abrasives present in the drilling fluid. Preferably, the parts are solid ceramic, however in other embodiments ceramic coatings can be used. Preferably, the ceramic is highly impact resistant and resistant to temperature changes within operating ranges of fluid pulse valve 100 (i.e. up to 400° F.). The ceramic is also preferably resistant to acidic corrosion, which can be an issue in certain wells. In a preferred embodiment, the ceramic material is zirconium dioxide (ZrO₂) also known as zirconia. For example, the zirconia may be NILCRA™, produced by Morgan Advanced Materials. Other ceramics may include, for example partially stabilized zirconia (PSZ) and silicon nitride (Si₃N₄).

During drilling, for example, drilling fluid enters fluid pulse valve 100 at end 105. The fluid flows into a cavity surrounding anchor 120 and within housing 115. The fluid continues around gearbox 150 and over stator tube 2. Then, the fluid flows though slots 3 in stator tube 2 and into the interior of stator tube 2. As the fluid flows through the interior of stator tube 2, it forces turbine 34 to rotate, which forces the gears in gearbox 150 to turn, which, in turn, rotate closer 35. As closer 35 is rotated, slots 3 become covered and uncovered by closer 35, causing the fluid to stop and restart, thereby creating pulses in fluid pulse valve 100.

Preferably, due to the high speed and pressure of the fluid passing through fluid pulse valve 100, fluid pulse valve 100 vibrates the entire drill string. For example, fluid pulse valve 100 can vibrate the drill string at 0.1 Hz, 3 Hz, 5 Hz, 7 Hz, 10 Hz, or another rate. As described herein, changing various elements of fluid pulse valve 100 can change the frequency at which fluid pulse valve 100 vibrates. In a preferred embodiment, the vibration rate may be chosen or tuned to a desired frequency or frequency range based on the application. For example, a low frequency pulse can be designed to have a strong thrust effect, while a higher frequency pulse might not thrust as strongly, but it can be designed to reduce friction between the drill string and the bore to help keep cuttings stirred up and entrained in the drilling fluid or to add micro-vibration assistance to the cutters of a drill head or reamer.

In the preferred embodiment, fluid pulse valve 100 is positioned 1500 to 2000 feet uphole of the bottom hole assembly (BHA) however, fluid pulse valve 100 can be attached to the BHA, positioned adjacent to the BHA, or at another distance from the BHA. Preferably, fluid pulse valve 100 has no bypass so that all of the fluid flows though fluid pulse valve 100. In some embodiments, multiple fluid pulse valves 100 can be installed on a drill string. All of the fluid pulse valves 100 in a drill string may produce the same frequency vibrations or may produce different frequency vibrations with each fluid pulse valve 100 tuned to a specific frequency. Certain frequencies may have more of an effect at specific locations in the drill string. The multiple fluid pulse valves 100 may be placed adjacent to each other or at a distance from each other. In other embodiments, a single fluid pulse valve 100 may be able to produce multiple frequencies either simultaneously or sequentially.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. All such similar substitutes and modifications apparent to those skilled in the art are deemed to be within the spirit, scope and concept of the disclosure as defined by the appended claims.

1. A fluid pulse valve for use in a drill string comprising:
an outer housing;
a rotor contained within the outer housing;
a stator tube surrounding the rotor and adjacent to the outer housing, the stator tube comprising a plurality of slots arranged in a helix on the stator tube; and
a helical closer rotationally coupled to the rotor, wherein at least a portion of the helical closer is adapted to align with the plurality of slots as the closer rotates so as to cover and to uncover the plurality of slots to create at least one of a crescendoing pulse and a decrescendoing pulse when a fluid is pumped through the fluid pulse valve.

2. The fluid pulse valve of claim 1, wherein the fluid pulse valve is configured so that the fluid enters the outer housing, passes through the plurality of slots, into the stator tube, and rotates the rotor.

3. The fluid pulse valve of claim 1, further comprising at least one fixed flow area port in the stator tube.

4. The fluid pulse valve of claim 3, further comprising a gearbox, wherein a gear reduction within the gearbox is configured to cause the closer to rotate at a rate different than a rate at which the rotor rotates.

5. The fluid pulse valve of claim 4, wherein at least one of (a) a gear ratio of the gearbox and (b) a pitch of the rotor is adjustable to alter a pulse rate relative to a flow rate of the fluid.

6. The fluid pulse valve of claim 1, wherein a difference in a pitch of the helical closer and a pitch of the plurality of slots is configurable to adjust a change in a pressure created by the at least one of the crescendo pulse and the decrescendo pulse.

7. The fluid pulse valve of claim 1, further comprising an anchor coupled to the rotor.

8. The fluid pulse valve of claim 1, wherein the fluid pulse valve is configured to close and to open at a frequency of 0.1 to 10 Hz.

9. The fluid pulse valve of claim 1, wherein the fluid pulse valve does not include a fluid bypass.

10. The fluid pulse valve of claim 1, wherein at least one of (a) a quantity of the plurality of slots, (b) a size of at least one of the plurality of slots, and (c) a gap between at least one of the plurality of slots and the helical closer are configurable to adjust a change in a pressure created by the at least one of the crescendo pulse and the decrescendo pulse.

11. The fluid pulse valve of claim 1, wherein at least one of the helical closer and the stator is formed from a ceramic.

12. A drill string comprising:
a bottom hole assembly (BHA);
the fluid pulse valve of claim 1 positioned up hole from the bottom hole assembly.

13. The drill string of claim 14, wherein the fluid pulse valve further comprises an anchor coupled to the rotor, wherein the anchor, the rotor, and the helical closer are removable from the stator tube without removing a down hole portion of the drill string.

14. A method of vibrating a drill string, comprising:
providing a bottom hole assembly (BHA);
providing a fluid pulse valve positioned uphole of the BHA, the fluid pulse valve comprising:
an outer housing;
a rotor contained within the outer housing;
a stator tube surrounding the rotor and adjacent to the outer housing, the stator tube comprising a plurality of slots arranged in a helix on the stator tube; and
a helical closer rotationally coupled to the rotor, wherein at least a portion of the helical closer is configured to align with the plurality of slots as the closer rotates; and
passing a fluid through the fluid pulse valve to the BHA, wherein, in the fluid pulse valve, the fluid forces the helical closer to rotate, which covers and uncovers the plurality of slots to create at least one of a crescendoing pulse and a decrescendoing pulse, thereby vibrating the drill string.

15. The method of claim 14, wherein as fluid passes through the fluid pulse valve, the fluid enters the outer housing, passes through the plurality of slots, into the stator, and rotates the rotor.

16. The method of claim 14, further comprising rotating the helical closer at a rate different than a rate at which the rotor rotates.

17. The method of claim 14, further comprising adjusting a difference in a pitch of the helical closer and a pitch of the plurality of slots to adjust a change in a pressure created by the at least one of the crescendo pulse and the decrescendo pulse.

18. The method of claim 17, wherein at least one of gear ratio of the gearbox or pitch of the rotor is adjusted to alter pulse rate relative to flow rate for each fluid pulse valve.

19. The method of claim 14, wherein the fluid pulse valve further comprises an anchor coupled to the rotor and wherein the method further comprises removing the anchor, the rotor, and the helical closer from the stator tube without removing a down hole portion of the drill string from a well bore.

20. The method of claim 14, further comprising at least one of opening and closing the fluid pulse valve at a frequency of 0.1 to 10 Hz.
